(19) United States
(12) Patent Application Publication
(10) Pub. No.: US 2005/0247037 A1
(43) Pub. Date: Nov. 10, 2005

(54) Ventilation cover structure

(75) Inventors: Chun-Yao Chen, Chu-Nan (TW); Kuo-Wen Chen, Chu-Nan (TW)

Correspondence Address: TROXELL LAW OFFICE PLLC, SUITE 1404, 5205 LEESBURG PIKE, FALLS CHURCH, VA, 22041, US

(73) Assignee: Coretronic Corporation

(21) Appl. No.: 11/070,224

(22) Filed: Mar. 3, 2005

(30) Foreign Application Priority Data
May 7, 2004 (TW) 093113010

(51) Int. Cl. B01D 46/00

(52) U.S. Cl. 55/495

(57) ABSTRACT

This invention provides a ventilation cover structure which comprises a filter net and a ventilating cover. The filter net comprises network-structured holes. The ventilating cover comprises a first surface and a second surface. The second surface comprises positioning columns. The positioning columns of the ventilating cover and the network-structured holes of the filter net are engaged, so that the filter net is attached to the second surface of the ventilating cover.

### BACKGROUND OF THE INVENTION

1. Field of the Invention

The present invention relates to a ventilation cover structure, especially to a ventilation cover structure having a network-structured filter.

2. Description of the Prior Art

Most of the ventilation devices or radiators in general systems will use a filter net to filter out dust or particles, so as to provide cleaner air or to prevent dust and particles from affecting the normal functions of systems. The filter net usually uses adhesive tape or material of agglutination to attach itself onto the ventilation cover.

As mentioned, the ventilating cover and filter net of prior art are usually adhered together by agglutination. When the ventilating cover and the filter net are adhered together on the production line, a layer of glue is first spread on the ventilating cover or the filter net. When undergoing the action of adhesion, the ventilating cover needs to be precisely positioned with the filter net, so that they can be accurately adhered together. Furthermore, a layer of glue needs to be spread between the ventilating cover and filter net for adhesion, but if the filter net needs to be changed in the future, it will not be easy to separate the ventilating cover and filter net, thus causing problems when the filter net needs to be changed. Therefore, the method to assemble the ventilating cover and filter net in the prior art is not only troublesome but time-consuming, and it will be difficult to change the filter net.

In the prior art, there is also another method of assembling which directly clamps the filter net between the ventilating cover and the case of radiator, but the filter net and the ventilating cover are not inter-engaged. In this method, since the filter net and ventilating cover are not inter-engaged, the filter net has not been fixed in position during the process of assembling; therefore, the filter net will easily slip off or drop from its position and not be able to accurately be fixed in the predetermined position, thus increasing the difficulty of structure assembly.

Therefore, the main goal of the present invention is to provide a ventilating cover structure to overcome the above problem and to reduce the time spent on structure assembly.

### SUMMARY OF THE INVENTION

The objective of the present invention is to provide a ventilating cover structure which can facilitate a quick assembly of the ventilating cover structure and the filter net, so as to shorten the time of the assembly of related products.

The present invention is a ventilating cover structure which consists of a filter net and a ventilating cover. The filter net consists of a plurality of network-structured holes. The ventilating cover consists of a first surface and a second surface, and the second surface consists of a plurality of positioning columns. The positioning columns and the network-structure holes are inter-engaged with each other, so that the filter net is attached onto the second surface of the ventilating cover.

The present invention is a radiator which consists of a case, a fan, a ventilation cover, and a filter net. The fan and the ventilation cover are arranged on the case. The ventilation cover consists of a first surface and a second surface, and the second surface consists of a plurality of positioning columns. The filter net consists of a plurality of network-structure holes. The positioning columns and the network-structure holes are inter-engaged with each other, so that the filter net is attached onto the second surface of the ventilating cover.

The ventilating cover structure of the present invention is formed because the positioning columns on the ventilating cover and the network-structure holes of the filter net are inter-engaged; therefore, the assembling of the filter net and the ventilating cover is easy, and it may save on time when this product of the ventilating cover structure is assembled.

The advantage and spirit of the invention may be understood by the following recitations together with the appended drawings.

### BRIEF DESCRIPTION OF THE APPENDED DRAWINGS

FIG. 1 is a schematic diagram of a ventilating cover structure of the present invention.

FIG. 2 is a schematic diagram of a radiator of the present invention.

FIG. 3 is a schematic diagram of the present invention applied in a television.

### DETAILED DESCRIPTION OF THE INVENTION

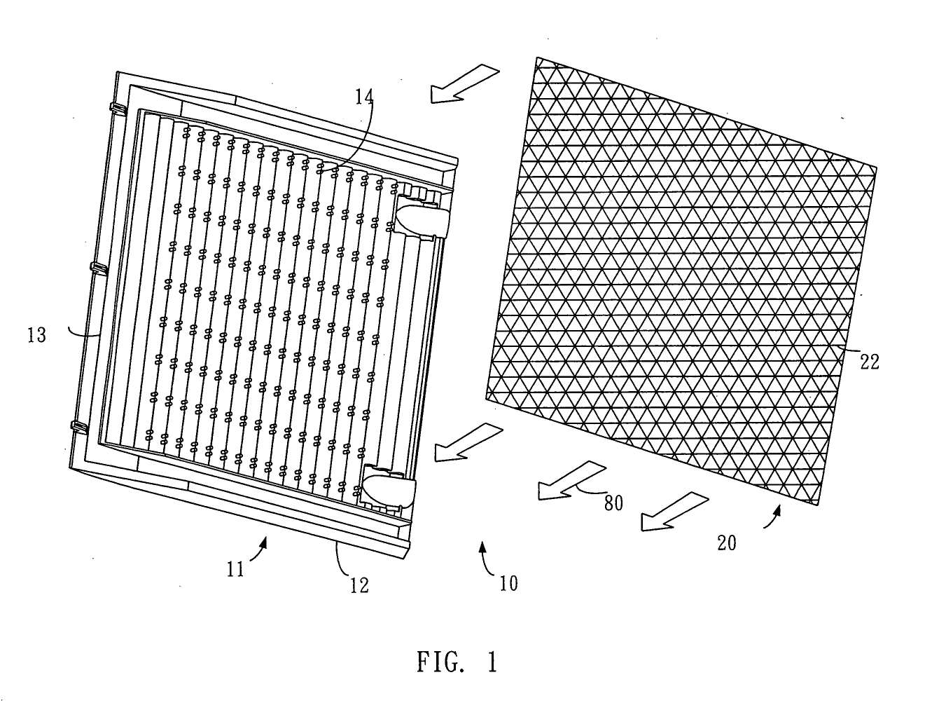

Please refer to FIG. 1. FIG. 1 is a schematic diagram of a ventilating cover structure 10 of the present invention. In an embodiment, the ventilating cover structure 10 consists of a ventilating cover 11 and a filter net 20. The ventilating cover 11 consists of a first surface 12 and a second surface 13.

The ventilating cover 11 is basically in the shape of a sheet, consisting a plurality of ventilating holes, wherein the two biggest surfaces are the first surface 12 and second surface 13; the first surface 12 is basically parallel with the second surface 13, and it is located opposite to the second surface 13.

The second surface 13 of the ventilating cover 11 consists of a plurality of positioning columns 14. The positioning columns 14 are arranged in a form of an array on the second surface 13 of the ventilating cover 11. Please refer to the embodiment of FIG. 1. Each of the positioning columns is a cylinder of plastic material.

The filter net 20 consists of a plurality of network-structure holes 22. The positioning columns 14 and the network-structure holes 22 are inter-engaged, so the filter net 20 is attached onto the second surface 13 of the ventilating cover 11. In another embodiment, the filter net 20 is not evenly and neatly arranged as in FIG. 1. The inner diameters of the network-structure holes 22 of the filter net 20 are not completely the same, and the intervals between the network-structured holes 22 of the filter net 20 are not completely the same either; the filter net 20 may simultaneously consist of a plurality of network-structure holes 22 that are bigger than or smaller than the area of the first surface (Not shown in FIG. 1) of the second surface 13 of the positioning columns 14 parallel with the ventilating cover 11. When the inner diameter of each network-structure hole 22 is smaller than the area of the first surface (Not shown in FIG. 1) of each positioning column 14, the elastic property of the filter net 20 allows the network-structured holes 22 to expand to an area that is bigger than the area of first surface (Not shown in FIG. 1) of the positioning columns 14, so that the network-structure holes 22 and positioning columns 14 are inter-engaged, and the filter net 20 is attached onto the second surface 13 of the ventilating cover 11.

As shown in FIG. 1, the arrow 80 represents the direction that the filter net 20 and ventilating cover 11 is inter-engaged by a plurality of positioning columns 14 of the second surface 13 on the ventilating cover 11. Compared with the assembling method of the ventilating cover and filter net of the prior art which uses the inconvenient way of agglutination, the present invention assembles the filter net 20 and ventilating cover 11 by inter-engaging their parts, so this invention is very convenient.

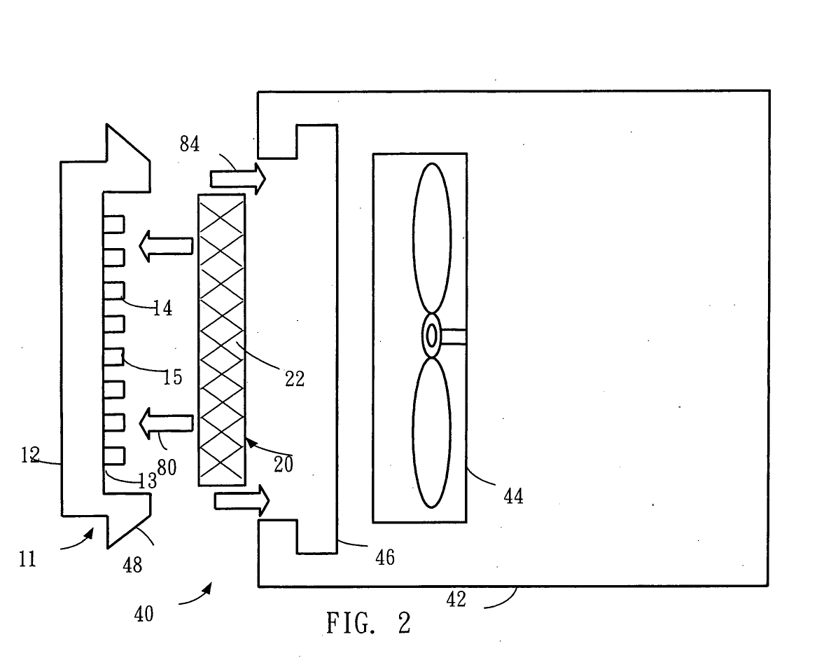

Please refer to FIG. 2. FIG. 2 is a schematic diagram of a radiator 40 of the present invention. In an embodiment, the radiator 40 of the present invention consists of a case 42, a fan 44, a ventilation cover 11, and a filter net 20. The fan 44 is attached onto the case 42. The fan 44 produces an air current to carry out the cooling function.

The case 42 consists of a plurality of troughs 46, and the ventilation cover 11 consists of a plurality of retainers 48. The troughs 46 and the retainers 48 are engaged with each other, and the arrow 84 represents the direction that the ventilation cover 11 is attached onto the case 42. With these troughs and retainers inter-engaged with each other, the ventilation cover 11 can be rapidly assembled onto the case 42.

The ventilation cover 11 consists of a first surface 12 and a second surface 13; the second surface 13 consists of a plurality of positioning columns 14 which are arranged in a form of an array. Each of the positioning columns 14 is a cylinder of plastic material. The filter net 20 consists of a plurality of the network-structure holes 22. The positioning columns 14 and the network-structure holes 22 are engaged with each other; the arrow 84 represents the direction that the filter net 20 is attached onto the second surface 13 on the ventilation cover 11. With the positioning columns 14 and the network-structure holes 22 inter-engaged with each other, the filter net 20 can be rapidly assembled onto the ventilation cover 11.

Please refer to FIG. 2. In this embodiment, there is a possibility that the inner diameter of the network-structure holes 22 of the filter net 20 are not the same, and the intervals between the network-structure holes in the filter net 20 are not the same either. When the inner diameter of each network hole 22 is smaller than the first surface area 15 of the second surface 13 of each positioning columns 14 which is parallel to the ventilation cover 11, the network-structured holes 22 of the filter net 20 are enlarged by the elastic property of the material, so the surface of the network-structured holes 22 are bigger than the first surface area 15 of the positioning columns 14. In this way, the positioning columns 14 can fit through the network-structured holes 22, so the network-structured holes 22 are engaged with the positioning columns 14, and the filter net 20 is attached onto the second surface 13 of ventilating cover 11.

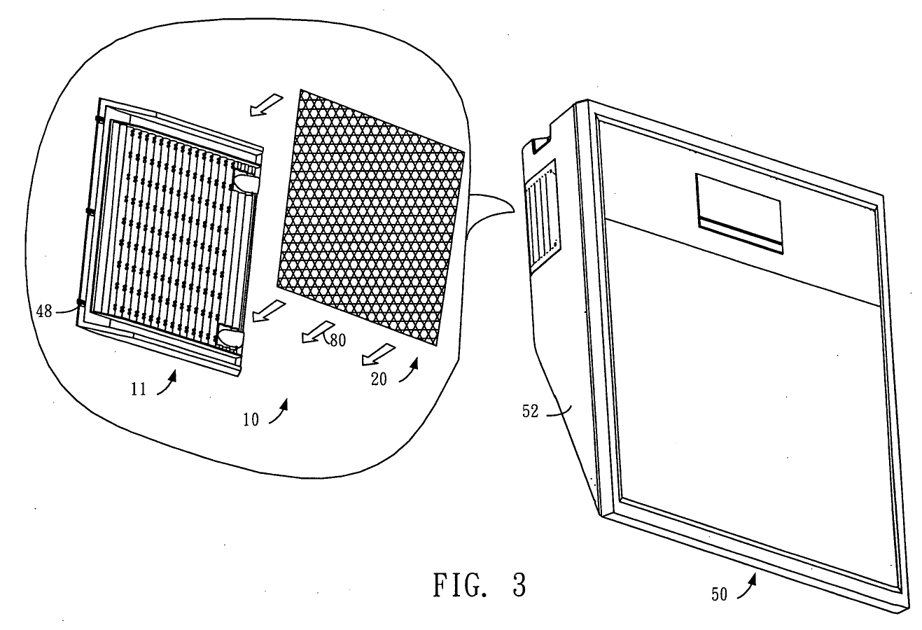

Please refer to FIG. 2 and FIG. 3. FIG. 3 is a schematic diagram of a radiator 40 of the present invention applied in a television 50. In this embodiment, the radiator 40 of the present invention is used in a television 50. As shown in FIG. 3, the case 52 of the television 50 is the case 42 of the radiator 40 of the present invention. The filter net 20 and the positioning columns 14 of the ventilating cover 11 are engaged by the network-structure holes 22, in the direction shown by the arrow 80. The case 52 of the television 50 are engaged with the ventilating cover 11 by its plurality of trough (Not shown in FIG. 3) and the retainer 48 of the ventilating cover 11, so the ventilating cover 11 and the filter net 20 is attached onto the case 52 of television 50. The fan (Not shown in FIG. 3) is placed inside the television 50. The fan 44 can produce an air current to cool down the internal temperature in the television, so the radiator 40 of the present invention can be used for the cooling effect in the television 40.

In the embodiment in FIG. 3, a television is used for explaining the application of the radiator of the present invention; the ventilation cover structure and the radiator of the present invention can be applied in other devices using the filter net and the ventilating cover. In addition, the ventilation cover structure of the present invention is not only used where the network-structured holes of the filter net is bigger than the first surface area of the second surface of the ventilating cover, but it can also be applied in filter net where the network-structured holes is smaller than the first surface area of positioning columns, or in a filter net in which the above two kinds of network-structure holes simultaneously exist.

In the ventilating cover structure and the radiator of the present invention, positioning columns which correspond to the network-structure holes of filter net are added on the ventilating cover, so that when the positioning columns on the ventilating cover and the network-structure holes of the filter net are inter-engaged, and the filter net is attached onto the ventilating cover. In this way, the filter net will not slip off or fall off during assembly, so assembling the filter net and the ventilating cover is extremely easy, and it can also shorten the time of assembling the ventilating cover structure of the present invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A ventilation cover structure, comprising:
a filter net comprising a plurality of network-structured holes; and
a ventilating cover comprising a first surface and second surface, the second surface comprising a plurality of positioning columns, wherein the positioning columns and the network-structured holes are engaged with each other, so that the filter net is attached onto the second surface of the ventilating cover.

2. The ventilation cover structure of claim 1, wherein the positioning columns are arranged in a form of an array on the second surface.

3. The ventilation cover structure of claim 1, wherein each of the positioning column is a cylinder respectively.

4. The ventilation cover structure of claim 3, wherein the cylinder is made of a plastic material.

5. The ventilation cover structure of claim 1, wherein the filter net is made of a material with an elastic property.

6. The ventilation cover structure of claim 1, wherein the inner diameters of the network-structured holes are not the same, and the intervals between the network-structured holes are not the same.

7. The ventilation cover structure of claim 6, wherein when the inner diameter of each network-structured hole is smaller than the area of a first surface of each positioning column; the network-structured holes are inter-engaged with the positioning columns by the elastic property of the material which the filter net is made of.

8. The ventilation cover structure of claim 7, wherein the first surfaces of the positioning columns are parallel with the second surface of the ventilating cover.

9. A radiator, comprising:
a case; and
a fan arranged in the case; and
a ventilation cover arranged on the case, the ventilation cover comprising a first surface and a second surface, the second surface comprising a plurality of positioning columns; and
a filter net, comprising a plurality of network-structure holes, wherein the positioning columns and the network-structured holes are engaged with each other, so that the filter net is attached onto the second surface of the ventilating cover.

10. The radiator of claim 9, wherein the case comprising a plurality of troughs, and the ventilating cover comprising a plurality of retainers, wherein the troughs and the retainers are engaged with each other, so that the ventilating cover is attached onto the case.

11. The radiator of claim 9, wherein the positioning columns are arranged in a form of an array on the second surface.

12. The radiator of claim 9, wherein each of the positioning columns is a cylinder respectively.

13. The radiator of claim 12, wherein the cylinder is made of a plastic material.

14. The radiator of claim 9, wherein the filter net is made of a material with, an elastic property.

15. The radiator of claim 9, wherein the inner diameters of the network-structured holes are not the same, and the intervals between the network-structure holes are not the same.

16. The radiator of claim 15, wherein when the inner diameter of each network-structured hole is smaller than the area of a first surface of each positioning column; the network-structure holes are inter-engaged with the positioning columns by the elastic property of the material which the filter net is made of.

17. The radiator of claim 16, wherein the first surfaces of the positioning columns are parallel with the second surface of the ventilating cover.

18. The radiator of claim 9, wherein the case is a back case of a television.
